(19) United States
(12) Patent Application Publication
(10) Pub. No.: US 2026/0127816 A1
(43) Pub. Date: May 7, 2026

(54) INFORMATION PROCESSING METHOD, INFORMATION PROCESSING DEVICE, COMPUTER PROGRAM, AND INFORMATION PROCESSING SYSTEM

(71) Applicant: Sony Group Corporation, Tokyo (JP)

(72) Inventors: Shinichiro ABE, Kanagawa (JP); Takuto MOTOYAMA, Tokyo (JP); Masahiko TOYOSHI, Kanagawa (JP)

(73) Assignee: Sony Group Corporation, Tokyo (JP)

(21) Appl. No.: 19/118,789

(22) PCT Filed: Feb. 7, 2024
(86) PCT No.: PCT/JP2024/003990

§ 371 Date: Apr. 7, 2025

(30) Foreign Application Priority Data
Mar. 31, 2023 (JP) 2023-059177

(51) Int. Cl. G06T 17/00; G05D 1/24; G05D 105/80; G05D 109/20; G05D 111/10; G05D 111/30; G06T 7/70; G06V 20/17

(52) U.S. Cl. CPC G06T 17/00; G05D 1/24; G06T 7/70; G06V 20/17; G05D 2105/80; G05D 2109/20; G05D 2111/10; G05D 2111/32; G06T 2207/10032

(57) ABSTRACT

To enable efficient and accurate execution of processing for an object (processing target) existing around a moving body. An information processing system according to an embodiment acquires an image captured by an imaging device provided in a drone and/or a position of the imaging device. Then, the information processing system acquires processing candidate information indicating that an object on which processing based on a corresponding three-dimensional model is executable exists around the drone and/or the three-dimensional model of the object existing around the drone on the basis of the image captured by the imaging device and/or the position of the imaging device.

### TECHNICAL FIELD

The present disclosure relates to an information processing device, an information processing method, a computer program, and an information processing system.

### BACKGROUND ART

Autonomous moving bodies such as drones are being used in various fields. Drones are already used in practice for applications such as aerial photography, survey, inspection, photogrammetry (three-dimensional model generation), disaster relief, and transportation logistics.

For example, survey or inspection can be performed by using autonomous movement of the drone. In this case, for example, after a subject as a survey target is set, a movement route of the drone for imaging the subject is generated. Thereafter, the drone autonomously moves according to the movement route and images the subject. In a case of using such autonomous movement, a desired work can be performed more efficiently than in a case where a person controls the drone.

On the other hand, currently, the above-described subject setting is manually performed. As a specific work, for example, after the subject on the image captured by the drone is surrounded by a bounding box, imaging processing is executed on the subject in the bounding box. Then, a rough three-dimensional model of the subject is generated on the basis of the captured image. In this way, the subject setting is completed. Then, the movement route is generated on the basis of the generated rough three-dimensional model.

However, in the above-described subject setting method, the imaging processing for generating a rough three-dimensional model takes time. In addition, in the imaging processing, the drone usually also captures an image of a range other than the subject. Therefore, it takes time and effort to remove an unnecessary image, and it also takes time to generate a rough three-dimensional model. Therefore, in the current subject setting method, for example, there is room for improvement regarding improvement efficiency of work performed before autonomous movement.

### CITATION LIST

### Patent Document

Patent Document 1: JP 2022-107269 A

### SUMMARY OF THE INVENTION

### Problems to Be Solved by the Invention

The present disclosure has been made in view of the above circumstances, and it is desirable to provide an information processing method, an information processing device, a computer program, and an information processing system that enable efficient and accurate execution of processing for an object (processing target) existing around a moving body.

### Solutions to Problems

An information processing method according to an embodiment of the present disclosure includes: an information acquisition step of acquiring an image captured by an imaging device provided in a moving body and/or a position of the imaging device; and a model information acquisition step of acquiring processing candidate information indicating that an object for which processing based on a corresponding three-dimensional model is executable exists around the moving body and/or the three-dimensional model of the object existing around the moving body on the basis of the image captured by the imaging device and/or the position of the imaging device.

An information processing device according to an embodiment of the present disclosure includes: an information acquisition unit that acquires an image captured by an imaging device provided in a moving body and/or a position of the imaging device; and a model information acquisition unit that acquires processing candidate information indicating that an object for which processing based on a corresponding three-dimensional model is executable exists around the moving body and/or the three-dimensional model of the object existing around the moving body on the basis of the image captured by the imaging device and/or the position of the imaging device.

A computer program according to an embodiment of the present disclosure causes a computer to execute: an information acquisition step of acquiring an image captured by an imaging device provided in a moving body and/or a position of the imaging device; and a model information acquisition step of acquiring processing candidate information indicating that an object for which processing based on a corresponding three-dimensional model is executable exists around the moving body and/or the three-dimensional model of the object existing around the moving body on the basis of the image captured by the imaging device and/or the position of the imaging device.

An information processing system according to an embodiment of the present disclosure includes: a moving body; a first information processing device that communicates with the moving body; and a second information processing device that communicates with the first information processing device,
in which at least one of the first information processing device or the second information processing device includes: an information acquisition unit that acquires an image captured by an imaging device provided in the moving body and/or a position of the imaging device; and a model information acquisition unit that acquires processing candidate information indicating that an object for which processing based on a corresponding three-dimensional model is executable exists around the moving body and/or the three-dimensional model of the object existing around the moving body on the basis of the image captured by the imaging device and/or the position of the imaging device.

### BRIEF DESCRIPTION OF DRAWINGS

FIG. 1 is a diagram illustrating an information processing system including a client device, a moving body, and a server device according to an embodiment.

FIG. 2 is a block diagram illustrating configurations of the client device, the moving body, and the server device illustrated in FIG. 1.

FIG. 3 is a flowchart illustrating an example of processing executed by the information processing system illustrated in FIG. 1, the processing being processing of acquiring processing candidate information indicating that an object for which processing based on a corresponding three-dimensional model is executable exists around the moving body.

FIG. 4 is a diagram illustrating an example of the processing candidate information acquired by the processing illustrated in FIG. 3.

FIG. 5 is a view illustrating an example in which the processing candidate information illustrated in FIG. 4 is displayed on a display in a mode selectable by a user.

FIG. 6 is a flowchart illustrating an example of route planning processing with respect to the object executed by the information processing system illustrated in FIG. 1 on the basis of the three-dimensional model of the object existing around the moving body.

FIG. 7A is a view illustrating a state in which a target of the route planning processing illustrated in FIG. 6 is selected from the processing candidate information displayed on the display illustrated in FIG. 5.

FIG. 7B is a view conceptually illustrating a state in which a relative positional relationship between the three-dimensional model of the object acquired on the basis of the processing candidate information selected in FIG. 7A and the moving body is specified.

FIG. 7C is a view conceptually illustrating a state in which the route planning processing with respect to the object is executed on the basis of the three-dimensional model of the object acquired on the basis of the processing candidate information selected in FIG. 7A.

FIG. 8 is a flowchart illustrating another example of the route planning processing with respect to the object executed by the information processing system illustrated in FIG. 1 on the basis of the three-dimensional model of the object existing around the moving body.

FIG. 9A is a view illustrating a state in which a target of the route planning processing illustrated in FIG. 8 is selected from the processing candidate information displayed on the display illustrated in FIG. 5.

FIG. 9B is a view illustrating an example in which the processing candidate information selected in FIG. 9A is displayed on the display in another display mode.

FIG. 10A is a view illustrating a state in which a part of the processing candidate information displayed in FIG. 9B is selected.

FIG. 10B is a view conceptually illustrating a state in which a relative positional relationship between the three-dimensional model of the object acquired on the basis of the processing candidate information selected in FIG. 10A and the moving body is specified.

FIG. 10C is a view conceptually illustrating a state in which the route planning processing with respect to the object is executed on the basis of the three-dimensional model of the object acquired on the basis of the processing candidate information selected in FIG. 10A.

FIG. 11 is a diagram illustrating an example of other processing candidate information different from the example of FIG. 4 acquired by the three-dimensional model acquisition processing illustrated in FIG. 3.

FIG. 12 is a view illustrating an example in which the processing candidate information illustrated in FIG. 11 is displayed on the display.

FIG. 13A is a view illustrating a state in which the target of the route planning processing illustrated in FIG. 8 is selected from the processing candidate information displayed on the display illustrated in FIG. 12.

FIG. 13B is a view conceptually illustrating a state in which a relative positional relationship between the three-dimensional model of the object acquired on the basis of the processing candidate information selected in FIG. 13A and the moving body is specified.

FIG. 13C is a view conceptually illustrating a state in which the route planning processing with respect to the object is executed on the basis of the three-dimensional model of the object acquired on the basis of the processing candidate information selected in FIG. 13A.

FIG. 14 is a diagram illustrating an example of a hardware configuration of an information processing device that can configure the client device, the moving body, and the server device according to an embodiment.

### MODE FOR CARRYING OUT THE INVENTION

Hereinafter, an embodiment of the present disclosure will be described in detail with reference to the drawings.

### Information Processing System

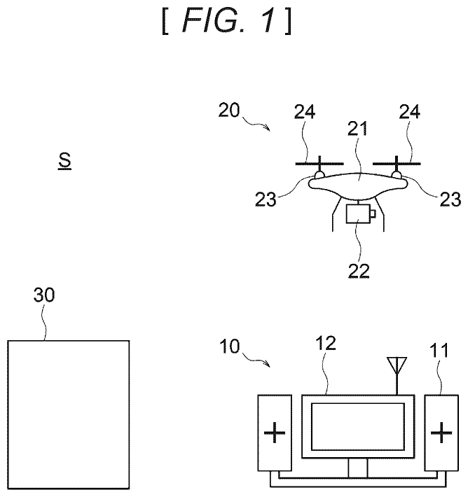

FIG. 1 illustrates an information processing system S according to an embodiment. The information processing system S includes a client device 10, a drone 20 as a moving body, and a server device 30. Note that, in a case of being simply referred to as a drone, this term means an unmanned flying object.

The client device 10 functions as a controller that remotely controls the drone 20. The client device 10 and the drone 20 can perform bidirectional wireless communication. The drone 20 can be controlled by manual operation. In the manual operation, the drone 20 receives, for example, a control command based on a user's intention transmitted from the client device 10 and is controlled on the basis of the control command. The control command is generated, for example, in a manner in which the user directly operates the client device 10. On the other hand, the drone 20 transmits, for example, a captured image and a current position to the client device 10. Furthermore, the drone 20 can also autonomously move (autonomously fly). In the autonomous movement, the drone 20 generates a movement route by itself, for example, or receives a movement route from, for example, the client device 10, and autonomously moves according to the movement route.

The client device 10 in the present embodiment is an operation-dedicated device gripped by the user and including an antenna that transmits the control command. As an example, the client device 10 includes an operation unit 11 operated by the user and a display 12. The user operates the operation unit 11 in a case of generating the control command for the drone 20. The display 12 can display, for example, a map image on which an indicator of the current position of the drone 20 is superimposed. Furthermore, the display 12 can display, for example, an image captured by the drone 20. Furthermore, the display 12 can display other various user interface (UI) images.

The display 12 may be integrated with the operation unit 11, or may be a device separated from the operation unit 11 such as 3D goggles (head-mounted display). The operation unit 11 may include at least one of a stick, a key, or a button. The operation unit 11 may be a mechanical component or may be a software component provided in a touch panel of the display 12.

Note that the client device 10 may be, for example, a smartphone, a tablet, a personal computer, or the like. For example, in a case where the client device 10 is implemented by a smartphone or a tablet, the client device 10 may directly transmit the control command according to a communication method such as Bluetooth (registered trademark). Furthermore, the control command may be transmitted to the drone 20 according to a communication method such as Wi-Fi.

The drone 20 includes an airframe 21 holding various control components and instruments, an imaging device 22, a plurality of motors 23, and a plurality of propellers 24. The airframe 21 supports the imaging device 22, the motors 23, and the propellers 24. The imaging device 22 images the surrounding of the drone 20. The motor 23 drives the propeller 24.

The server device 30 can perform bidirectional wireless communication with the client device 10. As will be described in detail later, the server device 30 specifies a three-dimensional model of an object such as a non-living object, a person, or an animal existing around the drone 20, and provides the three-dimensional model to the client device 10.

In the present embodiment, the server device 30 searches for and specifies the three-dimensional model of the object existing around the drone 20 on the basis of the image captured by the drone 20 and provided from the client device 10, the position of the drone 20 (the position of the imaging device 22), and the like. Then, the server device 30 provides the three-dimensional model to the client device 10 according to an instruction from the client device 10.

Once the three-dimensional model is provided to the client device 10 as described above, the client device 10 provides the three-dimensional model provided from the server device 30 to the drone 20. In response to this, the drone 20 can generate a movement route with respect to the object corresponding to the three-dimensional model on the basis of the provided three-dimensional model. The movement route is, for example, a route that goes around the object. As a result, the drone 20 can perform autonomous movement for, for example, survey, inspection, and photogrammetry (three-dimensional model generation) of the object.

Note that, for example, the expression of transmitting or receiving an image, a position, or a three-dimensional model in the present specification means accurately transmitting or receiving image information, position information, or three-dimensional model information as electronic information. In the present specification, information transmitted and received between the client device 10 and the drone 20, information transmitted and received between the client device 10 and the server device 30, information transferred inside the client device 10, information transferred inside the drone 20, and information transferred inside the server device 30 mean electronic information even in a case of being not specified by an expression including the term “information”.

### Configuration of Client Device

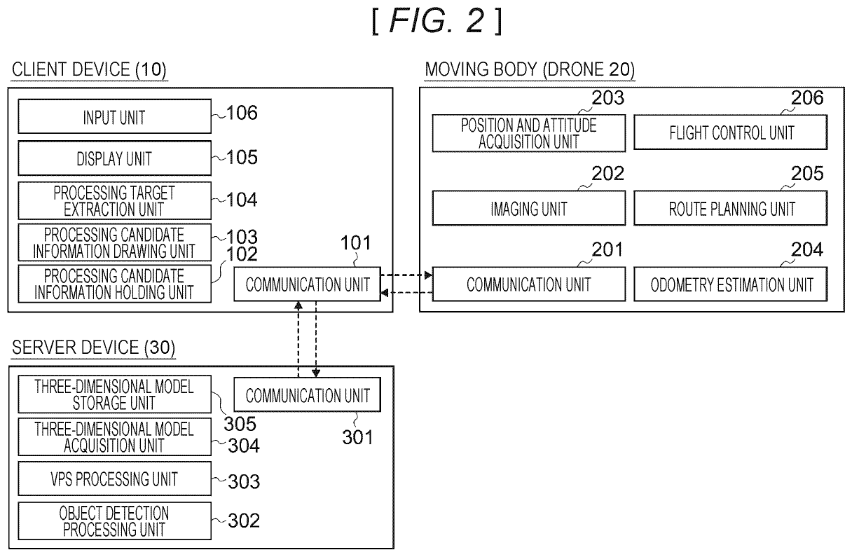

The client device 10 will be described in detail. FIG. 2 is a block diagram illustrating functional configurations of the client device 10, the drone 20, and the server device 30.

As illustrated in FIG. 2, the client device 10 includes a communication unit 101, a processing candidate information holding unit 102, a processing candidate information drawing unit 103, a processing target extraction unit 104, a display unit 105, and an input unit 106. Note that the client device 10 further includes a control command unit that generates the control command and the like, but the control command unit is not illustrated in FIG. 2.

The communication unit 101 communicates with the drone 20 and the server device 30 via an antenna. The communication unit 101 transmits the control command to the drone 20, for example. The communication unit 101 receives, from the drone 20, the image captured by the imaging device 22 of the drone 20, the position of the drone 20, and the like. The image captured by the imaging device 22 and received by the communication unit 101 may be one or a plurality of still images or a moving image. The position of the drone 20 includes position coordinates (latitude, longitude, and altitude) of the drone 20 and an orientation of the drone 20. Here, the position and orientation of the drone 20 are treated as the position and imaging direction of the imaging device 22 in the present embodiment. Hereinafter, information including the position coordinates and the orientation (imaging direction) of the drone 20 may be referred to as a moving body pose.

As described above, the client device 10 in the present embodiment provides the three-dimensional model provided from the server device 30 to the drone 20 according to an instruction. In this case, the three-dimensional model is transmitted from the communication unit 101 to the drone 20.

Here, in the present embodiment, as processing executed before the three-dimensional model is provided from the server device 30 to the client device 10, the client device 10 first transmits the moving body pose and the image received from the drone 20 to the server device 30, and receives the processing candidate information related to the three-dimensional model of the object existing around the drone 20 from the server device 30.

The processing candidate information is information indicating that an object for which processing based on a corresponding three-dimensional model is executable exists around the drone 20. In other words, the processing candidate information is information indicating that an object detected as existing around the drone 20 has an existing acquirable three-dimensional model, and processing based on an electronic three-dimensional model of the object is possible. The processing candidate information includes, for example, simple information capable of specifying an outline of an object that can be a target of processing based on the three-dimensional model, and indicates, to the user, a candidate of an acquirable three-dimensional model or a candidate of an object for which route planning processing is executable. After such candidate processing information is provided, once an instruction (operation) to acquire the three-dimensional model corresponding to the processing candidate information is confirmed from the user, the client device 10 transmits, to the server device 30, a three-dimensional model acquisition command, and the communication unit 101 receives the three-dimensional model from the server device 30.

Furthermore, the communication unit 101 may be connected to a network such as the Internet to transmit and receive information. In the present embodiment, the communication unit 101 is connected to the server device 30 via the network. The communication unit 101 can transmit information to the server device 30 via the network and can receive information from the server device 30.

Any communication method may be used as a communication method of the communication unit 101. As an example, the communication method may be based on the IEEE 802.11 standard, the IEEE 802.15.1 standard (Bluetooth (registered trademark) ), an OFDM modulation scheme, or other standards. A frequency band used for wireless communication is, for example, a 2.4 GHz band, a 5 GHz band, or other frequency bands.

The processing candidate information holding unit 102 receives, from the communication unit 101, the above-described processing candidate information provided from the server device 30 to the client device 10 and holds the processing candidate information.

The processing candidate information drawing unit 103 executes processing for displaying the processing candidate information provided from the server device 30 on the display 12 as described above. Specifically, the processing candidate information drawing unit 103 provides the processing candidate information and a display command to the display unit 105, and the display unit 105 displays the processing candidate information on the display 12. The processing candidate information displayed by the processing candidate information drawing unit 103 is an index for determining whether or not to execute processing on the object corresponding to the three-dimensional model by the user.

After the processing candidate information is provided from the server device 30 as described above, the processing target extraction unit 104 specifies the processing candidate information determined by the user in a case where the user determines to acquire the three-dimensional model related to the processing candidate information or execute processing (the route planning processing in this example) on the object. The processing target extraction unit 104 specifies the processing candidate information determined by the user from the processing candidate information holding unit 102. Then, the processing target extraction unit 104 provides the specified processing candidate information and the three-dimensional model acquisition command to the communication unit 101. In the present embodiment, the communication unit 101 transmits the processing candidate information, the three-dimensional model acquisition command, and the latest or recent image captured by the imaging device 22 to the server device 30. Thereafter, in a case where the three-dimensional model is provided from the server device 30 to the communication unit 101, the client device 10 transmits, from the communication unit 101, the three-dimensional model, a command (route planning command) for generating a movement route with respect to the object corresponding to the three-dimensional model, and the like to the drone 20.

In the present embodiment, as described above, the processing candidate information provided from the server device 30 is displayed on the display 12. Specifically, the user can determine or select an object (three-dimensional model) for which the route planning processing is desired to be executed on the basis of the processing candidate information displayed on the display 12. Specifically, the user can determine an object (three-dimensional model) corresponding to the processing candidate information as a processing target by performing a touch operation on the processing candidate information displayed on the display 12. The processing target extraction unit 104 specifies the processing candidate information determined by the user from the processing candidate information holding unit 102 according to the touch operation of the user.

Once the processing candidate information drawing unit 103 provides the processing candidate information and the display command as described above, the display unit 105 executes processing of displaying the processing candidate information on the display 12. In addition, the display unit 105 can display, for example, the map image on which the indicator of the current position of the drone 20 is superimposed, the image captured by the drone 20, and the like on the display 12 mainly during normal driving.

The input unit 106 is connected to the operation unit 11 and the display 12, and detects a user operation via the operation unit 11 and the display 12. The input unit 106 provides a signal corresponding to the detected user operation to the control command unit (not illustrated), the processing target extraction unit 104, and the like. For example, in a case where the user operates the operation unit 11 for manual operation of the drone 20, the signal is transmitted to the control command unit according to the operation, converted into the control command by the control command unit, and transmitted from the communication unit 101 to the drone 20. Furthermore, in a case where the user performs a touch operation on the processing candidate information displayed on the display 12 as described above, the signal is provided to the processing target extraction unit 104 according to the touch operation, and the processing candidate information corresponding to the touch operation is specified.

### Configuration of Drone

As illustrated in FIG. 2, the drone 20 includes a communication unit 201, an imaging unit 202, a position and posture acquisition unit 203, an odometry estimation unit 204, a route planning unit 205, and a flight control unit 206.

The communication unit 201 communicates with the client device 10 via an antenna. The communication unit 201 transmits, for example, the position of the drone 20, the image captured by the imaging device 22 of the drone 20, and the like to the client device 10. The position of the drone 20 is calculated by the odometry estimation unit 204 as described later. Furthermore, the communication unit 201 receives the control command, the three-dimensional model of the object existing around the drone 20 described above, and the like from the client device 10.

A communication method of the communication unit 201 may be the same as that of the communication unit 101 of the client device 10. The communication unit 201 may be connected to a network such as the Internet to transmit and receive information. As described above, the client device 10 may be, for example, a smartphone, a tablet, a personal computer, or the like. In this case, the communication unit 201 may receive the control command or the like via the network.

The imaging unit 202 controls the imaging device 22 and provides the image captured by the imaging device 22 to the communication unit 201. The communication unit 201 transmits the image provided from the imaging unit 202 to the client device 10. The imaging unit 202 may control the imaging direction (a direction of an optical axis of a lens), a zoom, a focus, and the like of the imaging device 22 according to the control command from the client device 10, for example.

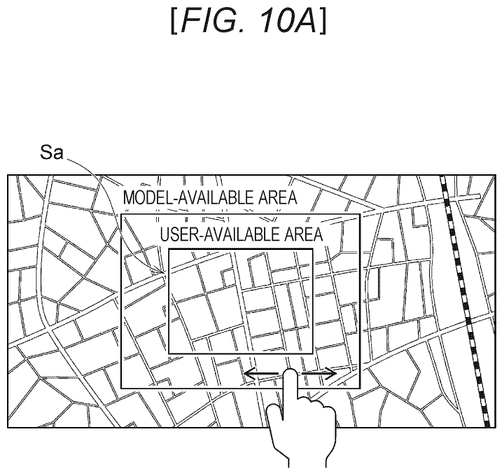

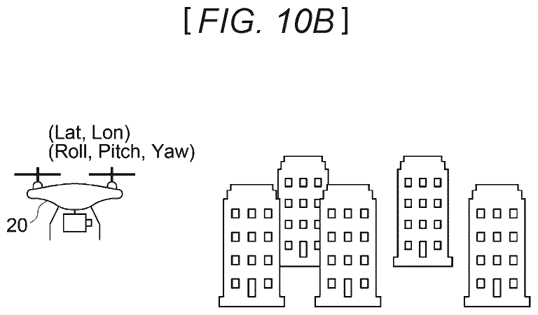

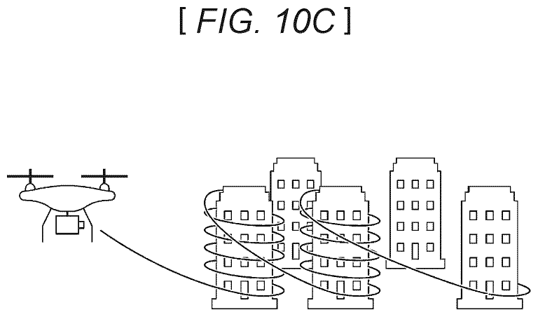

The position and posture acquisition unit 203 includes various sensors for detecting the position of the drone 20 and for detecting an obstacle or an object around the drone 20. In the present embodiment, the position and posture acquisition unit 203 includes, for example, a geomagnetic sensor, a barometric pressure sensor, and a global navigation satellite system (GNSS) receiver as various sensors. The position and posture acquisition unit 203 includes the geomagnetic sensor, the barometric pressure sensor, and the GNSS receiver as the sensors for detecting the position of the drone 20. Furthermore, the position and posture acquisition unit 203 may include any one of a stereo camera, a Lidar sensor, a time-of-flight (ToF) sensor, an infrared sensor, an ultrasonic sensor, a monocular camera, and an IMU, or a combination of two or more thereof, as the sensor for detecting an obstacle or an object around the drone 20. Here, the surrounding of the drone 20 means at least a range in which an obstacle or an object can be detected by various sensors mounted on the drone 20. However, the surrounding of the drone 20 means, in a broad sense, a range in which the drone 20 can practically perform route planning (autonomous movement) accompanied by specific processing such as survey, inspection, or photogrammetry from the current position. For example, as will be described later with reference to FIGS. 10A to 10C, in the present embodiment, it is also assumed that the drone 20 performs autonomous movement accompanied by specific processing for an object existing in a relatively wide area relatively far from the current position of the drone 20. In this case, the relatively far and relatively wide area is included in the surrounding of the drone 20. Therefore, the surrounding of the drone 20 can be defined in consideration of a cruising distance (battery capacity) of the drone 20 and the assumed autonomous movement range. The surrounding of the drone 20 may be interpreted to mean, for example, a range within a radius of 10 Km, a range within a radius of 5 Km, a range within a radius of 3 Km, a range within a radius of 2 Km, a range within a radius of 1 Km, or a range within a radius of 500 m from the center of the drone 20.

The geomagnetic sensor measures the orientation of the drone 20 by measuring geomagnetism. The geomagnetic sensor provides the orientation of the drone 20, in particular, a traveling direction, to the odometry estimation unit 204 and the flight control unit 206. The barometric pressure sensor measures a barometric pressure. The barometric pressure sensor provides the barometric pressure to the odometry estimation unit 204 and the flight control unit 206. The barometric pressure varies depending on the height from the ground surface. Therefore, the altitude of the drone 20 can be calculated on the basis of the barometric pressure measured by the barometric pressure sensor. The GNSS receiver receives a signal from a global positioning system (GPS) satellite or another satellite (for example, Galileo or QZSS), and detects the current position (latitude, longitude, and altitude) of the drone 20 on the basis of the received signal. The GNSS receiver provides the detected current position of the drone 20 to the odometry estimation unit 204 and the flight control unit 206.

The odometry estimation unit 204 specifies the position of the drone 20 on the basis of the information provided from the position and posture acquisition unit 203. Specifically, the odometry estimation unit 204 specifies the position coordinates (latitude, longitude, and altitude) of the drone 20 and the orientation of the drone 20. That is, the odometry estimation unit 204 specifies the moving body pose. Note that, as described above, information regarding the position and orientation of the drone 20 is treated as information regarding the position and imaging direction of the imaging device 22. The moving body pose specified by the odometry estimation unit 204 is provided to the communication unit 201 and the route planning unit 205. The communication unit 201 transmits the provided moving body pose to the client device 10.

The route planning unit 205 generates the movement route for autonomous movement on the basis of the moving body pose provided from the odometry estimation unit 204. For example, Once a return command is received from the client device 10, the route planning unit 205 generates a movement route from the current position coordinates specified from the moving body pose to a return point (for example, the client device 10).

Further, once the three-dimensional model, the command for generating a movement route with respect to the object corresponding to the three-dimensional model (route planning command), and the like are received from the client device 10, the route planning unit 205 generates the movement route with respect to the object corresponding to the three-dimensional model on the basis of the moving body pose provided from the odometry estimation unit 204 and the information such as the three-dimensional model. The movement route generated by the route planning unit 205 is provided to the flight control unit 206.

The flight control unit 206 is a so-called flight controller that controls driving of the drone 20. For example, in a case where the drone 20 is manually operated, the flight control unit 206 receives the control command transmitted from the client device 10, and controls driving of the drone 20 on the basis of the control command. Furthermore, in a case where the movement route is provided from the route planning unit 205 as described above, the flight control unit 206 controls driving of the drone 20 in such a way that the drone 20 autonomously flies along the movement route.

### Server Device

As illustrated in FIG. 2, the server device 30 includes a communication unit 301, an object detection processing unit 302, a visual positioning system (VPS) processing unit 303, a three-dimensional model acquisition unit 304, and a three-dimensional model storage unit 305.

The communication unit 301 communicates with the client device 10. The communication unit 301 receives the position and the image of the drone 20 from the client device 10. Then, the communication unit 301 transmits the processing candidate information and/or the three-dimensional model corresponding to the processing candidate information to the client device 10 on the basis of the position and the image of the drone 20. The processing candidate information is information indicating that an object for which processing based on a corresponding three-dimensional model is executable exists around the drone 20 as described above. The three-dimensional model is electronic information for specifying the shape of the object.

The processing candidate information and the three-dimensional model related thereto are specified by the object detection processing unit 302, the VPS processing unit 303, the three-dimensional model acquisition unit 304, and the three-dimensional model storage unit 305. The communication unit 301 transmits the position and the image of the drone 20 received from the client device 10 to the object detection processing unit 302 and the VPS processing unit 303. Once the position and the image of the drone 20 are transmitted from the client device 10 to the server device 30, the object detection processing unit 302 and the VPS processing unit 303 search for an object of which a three-dimensional model is acquirable and which exists around the drone 20 in cooperation with the three-dimensional model acquisition unit 304 and the three-dimensional model storage unit 305. In a case where the existence of the object is confirmed, first, the communication unit 301 transmits the processing candidate information to the client device to 20. Thereafter, the three-dimensional model corresponding to the processing candidate information is transmitted to the client device 10 according to an instruction.

The communication unit 301 is connected to a network such as the Internet to transmit and receive information to and from the client device 10. A communication method of the communication unit 301 may be the same as that of the communication unit 101 of the client device 10.

Once the image captured by the drone 20 is provided, the object detection processing unit 302 detects one or a plurality of objects existing around the drone 20 from the image captured by the drone 20 by image recognition. In addition, the object detection processing unit 302 specifies the position of the object detected in the image captured by the drone 20 with two-dimensional coordinates in the image. The two-dimensional coordinates may be coordinates of, for example, a rectangular bounding box enclosing the object, and in this case, the position of the object is specified with, for example, information of “(x1, x2, x3, x4), (y1, y2, y3, y4)” as the two-dimensional coordinates.

Furthermore, after detecting the object from the image, the object detection processing unit 302 provides information regarding the object to the three-dimensional model acquisition unit 304. The three-dimensional model acquisition unit 304 confirms whether or not there is a three-dimensional model corresponding to the object in the three-dimensional model storage unit 305 by referring to the three-dimensional model storage unit 305 on the basis of information regarding the object provided from the object detection processing unit 302, and provides the result to the object detection processing unit 302. Details thereof will be described later.

As described above, in a case where the three-dimensional model acquisition unit 304 provides a result indicating that there is a three-dimensional model corresponding to the object detected by the object detection processing unit 302, the object detection processing unit 302 transmits the processing candidate information related to the three-dimensional model corresponding to the object to the client device 10 via the communication unit 301. In this case, for example, in a case where a vehicle or a building is recognized from the image, the object detection processing unit 302 transmits the type of the vehicle, the name of the building, and the position of the vehicle or building in the image as information included in the processing candidate information. In this case, the type of the vehicle and the name of the building are acquired from the three-dimensional model storage unit 305 by the three-dimensional model acquisition unit 304.

The VPS processing unit 303 functions as a visual positioning system. The VPS processing unit 303 specifies, on the basis of the position of the drone 20 and the image captured by the drone 20, one or a plurality of objects of which a three-dimensional model is acquirable and which exists around the drone 20.

Specifically, the VPS processing unit 303 specifies an area around the drone 20, particularly, an area imaged by the imaging device 22 on the basis of the position of the drone 20, the imaging direction, and the captured image. At this time, the VPS processing unit 303 can identify whether the drone 20 is positioned outdoors or indoors from the position of the drone 20 and the image captured by the drone 20. Then, in a case where the drone 20 is positioned outdoors, the VPS processing unit 303 can specify the area imaged by the imaging device 22 from the position and the imaging direction of the drone 20. In addition, in a case where the drone 20 is positioned indoors, the VPS processing unit 303 can specify a predetermined area in the building imaged by the drone 20 in the building. Then, the VPS processing unit 303 provides information regarding the specified area to the three-dimensional model acquisition unit 304. Here, the three-dimensional model acquisition unit 304 confirms whether or not there is a three-dimensional model associated with the area in the three-dimensional model storage unit 305 by referring to the three-dimensional model storage unit 305 on the basis of the information regarding the area provided from the VPS processing unit 303, and provides the result to the VPS processing unit 303. Details thereof will be described later.

As described above, in a case where the three-dimensional model acquisition unit 304 provides a result indicating that there is a three-dimensional model (object) associated with the area specified by the VPS processing unit 303, the VPS processing unit 303 transmits the processing candidate information related to the specified area to the client device 10 via the communication unit 301. The processing candidate information related to the area is information indicating that an object for which processing based on a three-dimensional model is executable exists in the area as the surrounding of the drone 20.

For example, in a case where the drone 20 is positioned inside the building, the VPS processing unit 303 acquires information regarding a three-dimensional model of an internal structure of the building from the three-dimensional model acquisition unit 304 as information included in the processing candidate information, and transmits the information from the communication unit 301 to the client device 10. In this case, the VPS processing unit 303 may transmit the name of the building and the position information (third floor, coordinate position, direction, or the like) of the drone 20 in the building to the client device 10 as information included in the processing candidate information.

For example, in a case where the drone 20 is positioned outdoors, the VPS processing unit 303 acquires, from the three-dimensional model acquisition unit 304, information regarding an outdoor area including, for example, an acquirable three-dimensional model of the building or the like positioned in the imaging direction as information included in the processing candidate information, and transmits the information from the communication unit 301 to the client device 10. In this case, the VPS processing unit 303 transmits, for example, the name or address of the area to the client device 10 as information included in the processing candidate information.

In addition, the VPS processing unit 303 can specify a relative positional relationship between the drone 20 and an object around the drone 20. For example, in a case where the three-dimensional model of the inside of the building is acquired from the three-dimensional model acquisition unit 304, the VPS processing unit 303 can specify the coordinate position of the drone 20 inside the building on the basis of, for example, information regarding the position of the building, the captured image (an image of the inside of the building), and the imaging direction. The information regarding the coordinate position may be included as a part of the processing candidate information. Furthermore, in a case where the VPS processing unit 303 acquires, for example, a plurality of three-dimensional models corresponding to a plurality of buildings related to the area specified as described above from the three-dimensional model acquisition unit 304, the position of the area based on the drone 20 can be specified on the basis of, for example, the information regarding the position of the area, the captured image, and the imaging direction. The information regarding the position may be included as a part of the processing candidate information. The VPS processing unit 303 may hold object images of a plurality of viewpoints as dictionary data, and compare an image with the dictionary data to specify the relative positional relationship.

In addition, the VPS processing unit 303 can also specify the relative positional relationship between the drone 20 and the object detected by the object detection processing unit 302. In this case, the VPS processing unit 303 can specify the relative positional relationship between the drone 20 and the object from the moving body pose of the drone 20 and an image in which the object is captured.

the three-dimensional model acquisition unit 304 executes processing of searching for or acquiring a three-dimensional model of an object existing around the drone 20 from the three-dimensional model storage unit 305 according to a command from the object detection processing unit 302, the VPS processing unit 303, or the communication unit 301. The three-dimensional model storage unit 305 stores a three-dimensional model of an object such as a vehicle, a building, an internal structure of a building, a person, an animal, a traffic-related device such as a signal or a guardrail, or a tree. The three-dimensional model also includes information such as the position (latitude, longitude, or the like) or the address.

As described above, after the object detection processing unit 302 detects an object from an image, information regarding the object is provided to the three-dimensional model acquisition unit 304. At this time, the three-dimensional model acquisition unit 304 confirms whether or not there is a three-dimensional model corresponding to the object in the three-dimensional model storage unit 305 by referring to the three-dimensional model storage unit 305 on the basis of information regarding the object provided from the object detection processing unit 302.

The three-dimensional model acquisition unit 304 provides the confirmation result as to whether or not there is a three-dimensional model corresponding to the object detected from the image by the object detection processing unit 302 in the three-dimensional model storage unit 305 to the object detection processing unit 302. In a case where there is a three-dimensional model corresponding to the object detected from the image by the object detection processing unit 302 in the three-dimensional model storage unit 305, the three-dimensional model acquisition unit 304 acquires at least the name of the three-dimensional model from the three-dimensional model storage unit 305. The three-dimensional model acquisition unit 304 transmits the above-described name of the three-dimensional model acquired from the three-dimensional model storage unit 305 to the object detection processing unit 302 as information included in the processing candidate information. Then, the object detection processing unit 302 transmits the name of the three-dimensional model and the (held) position of the object corresponding to the three-dimensional model in the image as the processing candidate information.

Furthermore, as described above, the VPS processing unit 303 provides information regarding the area around the identified drone 20 to the three-dimensional model acquisition unit 304. At this time, the three-dimensional model acquisition unit 304 confirms whether or not there is a three-dimensional model associated with the area in the three-dimensional model storage unit 305 by referring to the three-dimensional model storage unit 305 on the basis of the information regarding the area provided from the VPS processing unit 303.

The three-dimensional model acquisition unit 304 provides, to the VPS processing unit 303, a confirmation result as to whether or not there is a three-dimensional model associated with the area specified by the VPS processing unit 303. In a case where there is a three-dimensional model (object) associated with the area specified by the VPS processing unit 303 in the three-dimensional model storage unit 305, the three-dimensional model acquisition unit 304 acquires the name and address of the specified area from the three-dimensional model storage unit 305. The VPS processing unit 303 transmits information regarding the name and address of the three-dimensional model and the relative positional relationship between the drone 20 and the area where the three-dimensional model exists to the client device 10 as the processing candidate information.

In addition, after the processing candidate information is provided from the server device 30 to the client device 10 described above, once the user determines, on the basis of the processing candidate information, to execute processing for an object corresponding to a three-dimensional model related to the processing candidate information, the client device 10 transmits the processing candidate information and the three-dimensional model acquisition command to the server device 30. At this time, the three-dimensional model acquisition unit 304 acquires the corresponding three-dimensional model from the three-dimensional model storage unit 305. Then, the three-dimensional model acquisition unit 304 transmits the acquired three-dimensional model from the communication unit 301 to the client device 10. At this time, in the present embodiment, the VPS processing unit 303 specifies the relative positional relationship between the drone 20 and the three-dimensional model corresponding to the processing candidate information, and information regarding the relative positional relationship is also provided to the client device 10.

Note that the three-dimensional model acquisition unit 304 may access an external three-dimensional model database different from the server device 30 instead of or in addition to the three-dimensional model storage unit 305 to search for or acquire the three-dimensional model.

### Processing in Information Processing System

Hereinafter, an example of processing executed in the information processing system S according to the present embodiment will be described.

### Processing Candidate Information Acquisition Processing

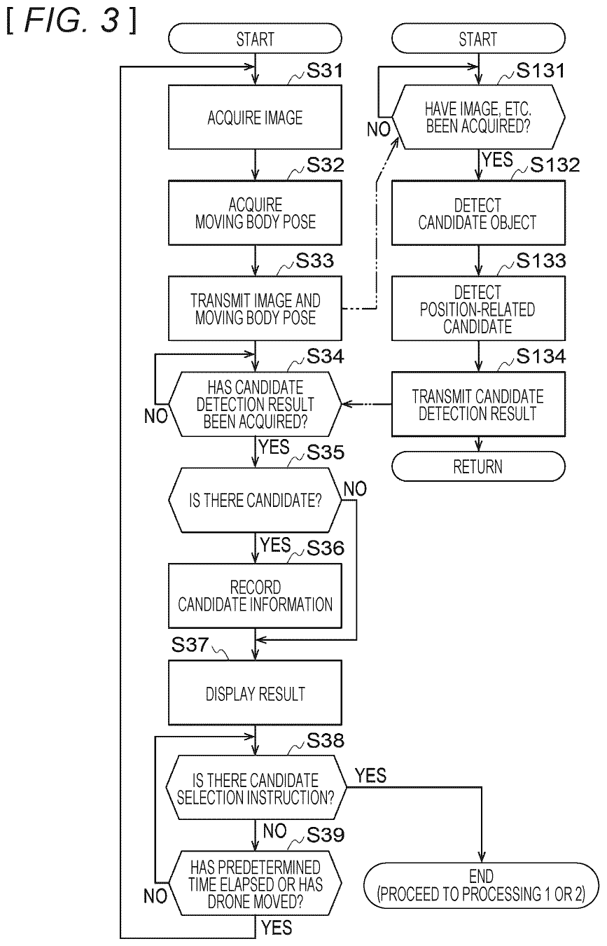

FIG. 3 is a flowchart illustrating an example of processing of acquiring the processing candidate information indicating that an object for which processing based on a three-dimensional model is executable exists around the drone 20 that is the moving body. In FIG. 3, the flowchart on the left side illustrates processing in the client device 10, and the flowchart on the right side illustrates processing in the server device 30. In this example, the processing illustrated in FIG. 3 is typically executed once the client device 10 and the server device 30 are powered on.

First, in step S31, the client device 10 acquires the image captured by the drone 20 from the drone 20.

Next, in step S32, the client device 10 acquires the moving body pose from the drone 20. As described above, the moving body pose is the position of the drone 20, and includes information regarding the position coordinates (latitude, longitude, and altitude) of the drone 20 and information regarding the orientation of the drone 20.

Here, in the present embodiment, the position and orientation of the drone 20 are treated as the position and imaging direction of the imaging device 22.

Next, in step S33, the client device 10 transmits the image and the moving body pose acquired in steps S31 and S32 to the server device 30. Thereafter, in step S34, the client device 10 waits for transmission of information from the server device 30, specifically, transmission of a candidate detection result to be described later.

In step S131, the server device 30 monitors whether or not the image and the moving body pose have been transmitted from the client device 10.

Then, in a case where the server device 30 receives the image and the moving body pose from the client device 10 (YES in step S131), the server device 30 first detects one or a plurality of objects existing around the drone 20 from the received image by image recognition performed by the object detection processing unit 302 in step S132. At this time, the object detection processing unit 302 specifies the position of the object detected in the image captured by the drone 20 with two-dimensional coordinates in the image.

Moreover, after detecting the object from the image, the object detection processing unit 302 provides information regarding the object to the three-dimensional model acquisition unit 304. At this time, the three-dimensional model acquisition unit 304 confirms whether or not there is a three-dimensional model corresponding to the object in the three-dimensional model storage unit 305 by referring to the three-dimensional model storage unit 305 on the basis of information regarding the object provided from the object detection processing unit 302. In a case where there is a three-dimensional model corresponding to the object detected from the image by the object detection processing unit 302 in the three-dimensional model storage unit 305, the three-dimensional model acquisition unit 304 acquires at least the name of the three-dimensional model from the three-dimensional model storage unit 305 and provides the name of the three-dimensional model to the object detection processing unit 302 as a part of the processing candidate information. Then, the object detection processing unit 302 holds information regarding the name of the three-dimensional model and the two-dimensional coordinates in the image of the object corresponding to the three-dimensional model as the processing candidate information. In a case where there is no three-dimensional model corresponding to the object detected from the image by the object detection processing unit 302 in the three-dimensional model storage unit 305, the object detection processing unit 302 holds information indicating that there is no candidate processing information.

Next, in step S133, the server device 30 causes the VPS processing unit 303 to specify an area around the drone 20, particularly, an area captured by the imaging device 22, on the basis of the position of the drone 20, the imaging direction, and the captured image. Then, the VPS processing unit 303 provides information regarding the specified area to the three-dimensional model acquisition unit 304. At this time, the three-dimensional model acquisition unit 304 confirms whether or not there is a three-dimensional model associated with the area in the three-dimensional model storage unit 305 by referring to the three-dimensional model storage unit 305 on the basis of the information regarding the area provided from the VPS processing unit 303. In a case where there is a three-dimensional model related to the area provided from the VPS processing unit 303 in the three-dimensional model storage unit 305, the three-dimensional model acquisition unit 304 acquires at least the name or address of the area from the three-dimensional model storage unit 305, and provides the name or address of the area to the VPS processing unit 303 as a part of the processing candidate information. Then, the VPS processing unit 303 holds the name or address of the area and a relative positional relationship between the area and the drone 20 as the processing candidate information. In a case where there is no three-dimensional model related to the area provided from the VPS processing unit 303 in the three-dimensional model storage unit 305, the VPS processing unit 303 holds information indicating that there is no candidate processing information.

Thereafter, in step S134, the server device 30 transmits the processing results of step S302 and step S303 (the candidate detection result: the processing candidate information or information indicating that there is no processing candidate) to the client device 10. In a case where the processing candidate information is extracted in the processing of step S302 and/or the processing of step S303, the processing candidate information is transmitted to the client device 10. In a case where the processing candidate information is not extracted in the processing of step S302 and the processing of step S303, the information indicating that there is no processing candidate information is transmitted to the client device 10.

In a case where the candidate detection result is transmitted from the server device 30 to the client device 10 in step S134, it is confirmed in step S34 that the client device 10 has received the candidate detection result from the server device 30, and the processing in the client device 10 proceeds.

Then, in step S35, the client device 10 confirms whether or not the processing candidate information is included in the information received from the server device 30 in step S34.

In a case where it is confirmed in step S35 that the processing candidate information is included (YES in step S35), the client device 10 records the received processing candidate information in the processing candidate information holding unit 102 in step S36.

On the other hand, in a case where it is confirmed in step S35 that the processing candidate information is not included (NO in step S35), after the processing of step S36, the client device 10 causes the processing candidate information drawing unit 103 to display a result indicating whether or not there is processing candidate information on the display 12 in step S37. Here, in step S37 after the processing of step S36, the client device 10 displays the processing candidate information on the display 12. In a case where the processing directly proceeds from step S35 to step S37, the client device 10 displays a result indicating that there is no processing candidate information on the display 12.

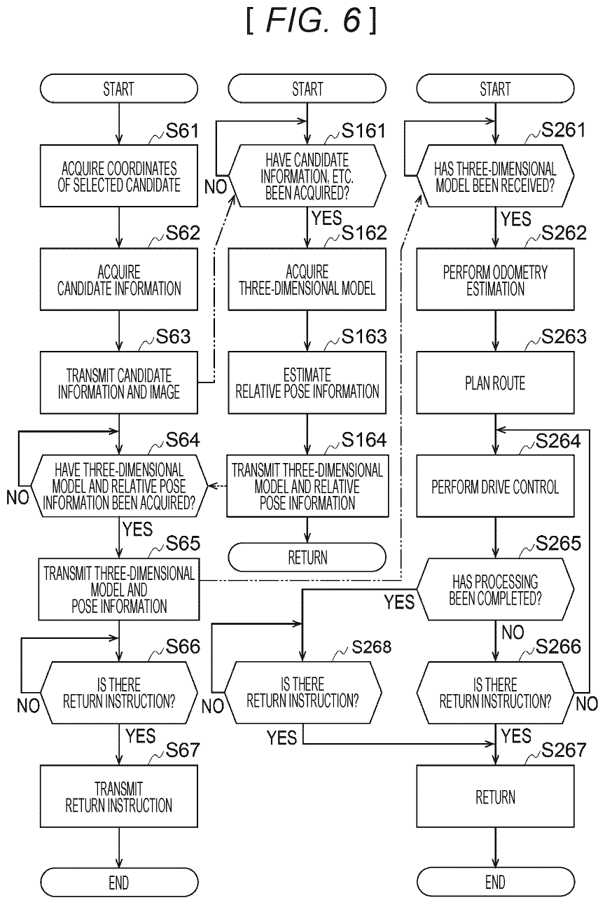

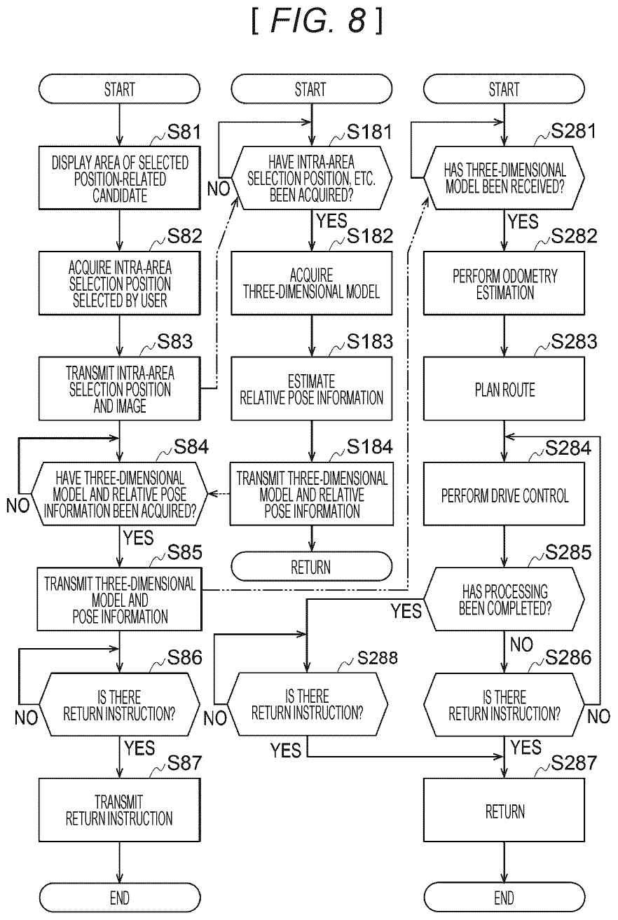

Next, in step S38, the client device 10 monitors whether or not an operation (candidate selection instruction) for selecting the processing candidate information displayed on the display 12 by the user has been performed in the present embodiment. In a case where the selection operation has been performed in step S38 (YES in step S38), the candidate information acquisition processing ends, and acquisition of the three-dimensional model and the route planning processing start (the processing illustrated in FIG. 6 or 8). On the other hand, in a case where the selection operation is not performed in step S38, the client device 10 confirms whether or not a predetermined time has elapsed or whether or not the drone 20 has moved in step S39. In a case where it is confirmed in step S39 that the predetermined time has not elapsed and the drone 20 has not moved, the processing returns to step S38. In a case where it is confirmed in step S39 that the predetermined time has elapsed or the drone 20 has moved, the processing returns to step S31, and processing candidate acquisition processing newly starts.

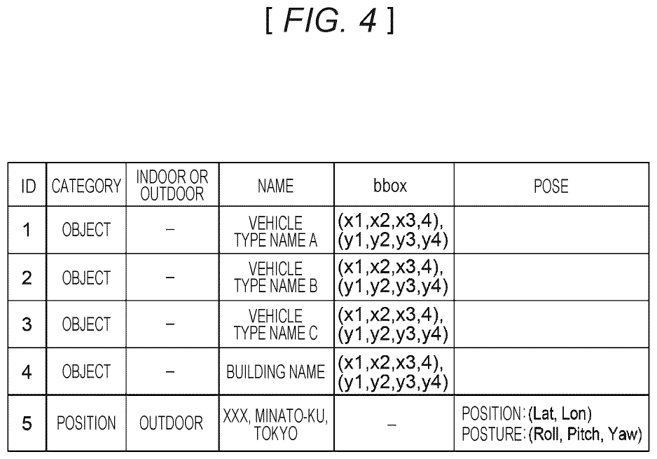

FIG. 4 illustrates an example of the processing candidate information acquired by the processing illustrated in FIG. 3. Numbers 1 to 5 shown in the leftmost ID column in the table illustrated in FIG. 4 indicate identification numbers of the processing candidate information. Pieces of processing candidate information ID1 to ID4 indicate processing candidate information indicating the object detected by the object detection processing unit 302 in step S132 as a processing candidate. Processing candidate information ID5 indicates processing candidate information indicating the area specified by the VPS processing unit 303 in step 133 as a processing candidate. In columns on the right side of ID1 to ID5, items (category, outdoor or indoor, name, bbox, and pose) for specifying each piece of processing candidate information are shown.

Specifically, the pieces of processing candidate information ID1 to ID3 are vehicles as the objects detected from the image captured by the drone 20, and indicate information regarding the vehicles of which corresponding three-dimensional models exist in the three-dimensional model storage unit 305. In the column of category related to ID1 to ID3, a notation of “object” is shown as the type of the information, the name of the vehicle is shown in the column of name, and two-dimensional coordinates of each vehicle on an image are shown in the column of bbox The processing candidate information ID4 is a building as the object detected from the image captured by the drone 20, and indicates information regarding the building of which a corresponding three-dimensional model exists in the three-dimensional model storage unit 305. The column of name shows the name of the building, and the column of bbox displays two-dimensional coordinates of the building on the image. The user can select any one of the pieces of processing candidate information ID1 to ID4. In a case where the user selects any one of the pieces of processing candidate information ID1 to ID4, processing for acquiring the three-dimensional model corresponding to the selected processing candidate information from the server device 30 is executed. Thereafter, in the present embodiment, the route planning processing with respect to the object corresponding to the three-dimensional model is executed on the basis of the acquired three-dimensional model.

In addition, the processing candidate information ID5 is the area captured by the imaging device 22 around the drone 20, and indicates information regarding the area where the associated three-dimensional model exists. In the column of category related to ID5, a notation of “position” is shown as the type of the information, “indoor” is shown, the address is shown in the column of name, and a relative positional relationship between the drone 20 and the area is indicated in the column of pose. In a case where the user selects the processing candidate information ID5, processing for acquiring the three-dimensional model related to the area from the server device 30 is executed.

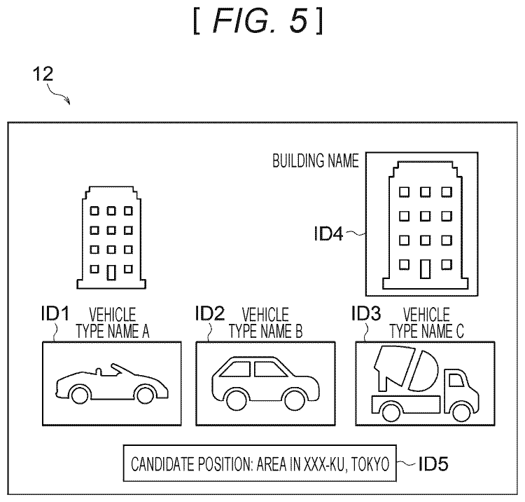

FIG. 5 illustrates an example in which the processing candidate information illustrated in FIG. 4 is displayed on the display 12. For example, the pieces of processing candidate information ID1 to ID5 may be displayed on the display 12 in a state of being superimposed on the image captured by the drone 20. In the present embodiment, the user can select desired processing candidate information by performing a touch operation on the display 12. Note that the table as illustrated in FIG. 4 may be displayed on the display 12.

### Route Planning Processing 1

Next, an example of acquisition of a three-dimensional model and the route planning processing based on the three-dimensional model will be described.

FIG. 6 is a flowchart illustrating an example of the route planning processing for an object existing around the drone 20 based on a three-dimensional model of the object. Specifically, FIG. 6 illustrates an example of the route planning processing in a case where the user selects the processing candidate information indicating the object detected by the object detection processing unit 302 in step S132 in FIG. 3 as the processing candidate.

In FIG. 6, three flowcharts are arranged in the left-right direction. The left flowchart in FIG. 3 illustrates processing in the client device 10, the center flowchart illustrates processing in the server device 30, and the right flowchart illustrates processing in the drone 20. The processing in the client device 10 starts with the operation of selecting the processing candidate information by the user as a trigger. In the present embodiment, as an example, the processing in the client device 10 illustrated in FIG. 6 starts with selection of the processing candidate information by a touch operation on the display 12 illustrated in FIG. 5 as a trigger.

First, in step S61, the client device 10 detects that the selection operation by the user has been performed, by using the input unit 106. With this detection, the client device 10 recognizes that the user has determined to execute processing for the object corresponding to the three-dimensional model related to the selected processing candidate information. Then, the processing target extraction unit 104 of the client device 10 acquires two-dimensional coordinates of the processing candidate information (selected candidate) selected by the user in the image on the basis of the operation from the user.

Next, in step S62, the client device 10 specifies the processing candidate information conforming to the two-dimensional coordinates acquired in step S61 from the information recorded in the processing candidate information holding unit 102 by the processing target extraction unit 104.

Next, in step S63, the client device 10 transmits the processing candidate information specified in step S62, the three-dimensional model acquisition command, and the latest or recent image captured by the imaging device 22 to the server device 30. The client device 10 periodically acquires the image captured by the drone 20. Thereafter, in step S64, the client device 10 waits for transmission of information from the server device 30, specifically, transmission of a three-dimensional model or the like.

In step S161, the server device 30 monitors whether or not the processing candidate information and the image have been transmitted from the client device 10.

Then, in a case where the server device 30 receives the processing candidate information, the image, and the like from the client device 10 (YES in step S161), in step S162, the server device 30 acquires the three-dimensional model corresponding to a processing candidate state from the three-dimensional model storage unit 305 by the three-dimensional model acquisition unit 304.

Next, in step S163, the server device 30 estimates, by the VPS processing unit 303, a relative positional relationship (hereinafter, referred to as relative pose information) between the drone 20 and the object corresponding to the three-dimensional model on the basis of the image received in step S161 and the three-dimensional model acquired in step S162. Here, as the relative pose information is estimated, for example, even in a case where the drone 20 moves from a time when the processing candidate information is acquired, the relative positional relationship between the drone 20 and the object corresponding to the three-dimensional model can be obtained again, and the subsequent route planning processing can be appropriately executed.

Next, in step S164, the server device 30 transmits the three-dimensional model acquired in step S162 and the relative pose information which is the relative positional relationship between the drone 20 and the object corresponding to the three-dimensional model estimated in step S163 to the client device 10. Thereafter, the server device 30 monitors transmission of new information from the client device 10 in step S161.

Then, once the three-dimensional model and the relative pose information estimated in step S163 are transmitted from the server device 30 to the client device 10 in step S164, it is confirmed in step S64 that the client device 10 has received the information from the server device 30, and the processing in the client device 10 proceeds.

Then, in step S65, the client device 10 transmits the three-dimensional model received in step S64, the relative pose information estimated in step S163, and the command for generating the movement route to the drone 20. Thereafter, route planning is performed in the drone 20. During the processing in the drone 20, the client device 10 monitors whether or not the user has made the return instruction in step S66 in the present embodiment. In a case where the return instruction has not been made, the client device 10 continues monitoring, and in a case where the return instruction has been made, the return instruction is transmitted to the drone 20 in step S67, and the processing is completed.

In step 261, the drone 20 monitors whether or not the three-dimensional model, the relative pose information, and the command for generating the movement route have been transmitted from the client device 10.

Then, in a case where the drone 20 receives the three-dimensional model, the relative pose information, and the like from the client device 10 (YES in step S261), in step S262, the drone 20 estimates, the odometry estimation unit 204, the current moving body pose of the drone 20. That is, the current position coordinates (latitude, longitude, and altitude) of the drone 20 and the orientation of the drone 20 are specified. Then, the drone 20 estimates, by the odometry estimation unit 204, a relative position between the actual position of the drone 20 and the object corresponding to the three-dimensional model on the basis of the three-dimensional model and the relative pose information received in step 261 and the current moving body pose of the drone 20 estimated in step S262.

Next, in step S263, the drone 20 generates, by the route planning unit 205, the movement route with respect to the object corresponding to the three-dimensional model on the basis of the relative position between the actual position of the drone 20 estimated in step S262 and the object corresponding to the three-dimensional model.

Thereafter, in step S264, the drone 20 performs control by the flight control unit 206 in such a way that flight according to the movement route generated in step S263 is performed. As a result, the drone 20 can perform survey, inspection, photogrammetry (three-dimensional model generation), and the like of the object by imaging the object while performing autonomous movement.

Then, in step S265, the drone 20 confirms whether or not the processing (for example, survey, inspection, acquisition of an image for photogrammetry, and the like) executed in parallel during autonomous movement has been completed. In a case where it is confirmed in step S265 that the processing has not been completed (NO in step S265), the drone 20 confirms whether or not the return instruction has been made in step S266, and in a case where it is confirmed that the return instruction has not been made (NO in step S266), control for autonomous movement is continued in step S264. In addition, in a case where it is confirmed in step S266 that the return instruction has been made, a return route is generated and the drone 20 returns in step S267.

On the other hand, in a case where it is confirmed in step S265 that the processing has been completed (YES in step S265), the drone 20 confirms whether or not the return instruction has been made in step S268, and in a case where it is confirmed that the return instruction has not been made (NO in step S268), monitoring is continued. Then, in a case where it is confirmed in step S268 that the return instruction has been made, a return route is generated and the drone 20 returns in step S267. Then, after the drone 20 returns, the processing ends.

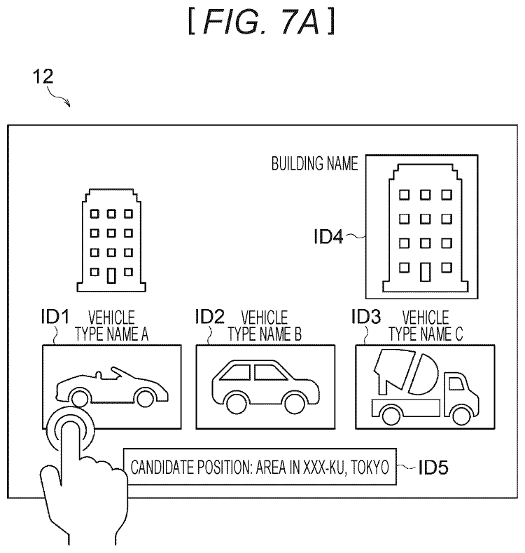

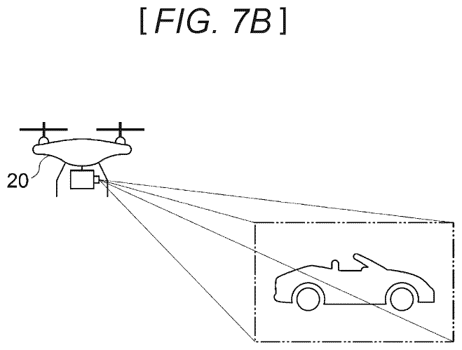

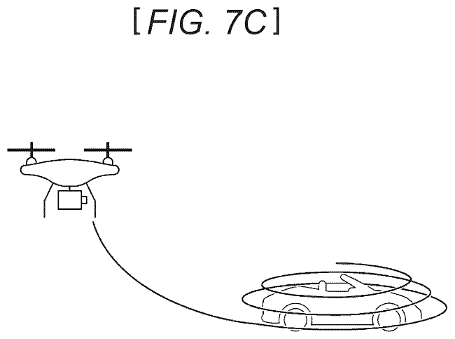

A specific example of a flow of the processing in FIG. 6 will be described with reference to FIGS. 7A to 7C. FIG. 7A illustrates a state in which a target of the route planning processing illustrated in FIG. 6 is selected from the processing candidate information displayed on the display 12 illustrated in FIG. 5. In FIG. 7A, as an example, the processing target candidate ID1 (see FIG. 5) specified with a vehicle type name A is selected as the target of the route planning processing.

The operation illustrated in FIG. 7A is detected in step S38 in FIG. 3, and with the detection as a trigger, the processing of FIG. 6 starts. Then, the processing candidate information selected by the user and the latest or recent image captured by the drone 20 are transmitted from the client device 10 to the server device 30 (step S63), and the server device 30 transmits a three-dimensional model corresponding to the processing candidate information selected by the user and a relative positional relationship (relative pose information) between an object corresponding to the three-dimensional model and the drone 20 to the client device 10 (steps S161 to S164). Then, the client device 10 transmits the three-dimensional model corresponding to the processing candidate information selected by the user and the relative positional relationship (relative pose information) between the object corresponding to the three-dimensional model and the drone 20 to the drone 20 (step S65).

Thereafter, the drone 20 estimates a relative position between the actual position of the drone 20 and the object corresponding to the three-dimensional model by using the three-dimensional model corresponding to the processing candidate information selected by the user, the relative pose information between the object corresponding to the three-dimensional model and the drone 20, and the current position of the drone 20 (step S262). FIG. 7B conceptually illustrates a state in which the relative positional relationship between the three-dimensional model of the object acquired on the basis of the processing candidate information selected in FIG. 7A and the drone 20 is specified. The odometry estimation unit 204 conceptually specifies the positional relationship as illustrated in FIG. 7B.

Thereafter, the drone 20 generates, by the route planning unit 205, a movement route with respect to the object corresponding to the three-dimensional model on the basis of the relative position between the actual position of the drone 20 and the object corresponding to the three-dimensional model (step S263). FIG. 7C conceptually illustrates a state in which the route planning processing for the object is executed on the basis of the three-dimensional model of the object acquired on the basis of the processing candidate information selected in FIG. 7A. The route planning unit 205 conceptually specifies the movement route as illustrated in FIG. 7C.

### Route Planning Processing 2

Next, another example of acquisition of a three-dimensional model and the route planning processing based on the three-dimensional model will be described. FIG. 8 illustrates an example of the route planning processing in a case where the user selects the processing candidate information related to the area specified by the VPS processing unit 303 in step S133 in FIG. 3.

In FIG. 8, three flowcharts are arranged in the left-right direction. The left flowchart in FIG. 8 illustrates processing in the client device 10, the center flowchart illustrates processing in the server device 30, and the right flowchart illustrates processing in the drone 20. The processing in the client device 10 starts with the operation of selecting the processing candidate information by the user as a trigger.

First, in step S81, the client device 10 detects that the selection operation by the user has been performed, by using the input unit 106. Then, in this example, the client device 10 displays an area (a map indicator, a building and a structure thereof (a floor structure or the like) ) corresponding to the processing candidate information (position-related candidate) selected by the user on the display 12.

Next, in step S82, the client device 10 confirms which portion the user has selected as the processing target in the area displayed on the display 12 in step S81. Hereinafter, the portion selected by the user confirmed in step S82 is referred to as an intra-area selected position. In the present embodiment, an aspect is adopted in which the user can select a range or a section to be a target of acquisition of a three-dimensional model from a part of or the entire area displayed on the display 12. Then, in a case where the user selects the intra-area selected position in step S82, the client device 10 recognizes that the user has determined to execute processing on the object corresponding to the three-dimensional model related to the selected processing candidate information.

Next, in step S83, the client device 10 transmits the intra-area selected position specified in step S82, the three-dimensional model acquisition command, and the latest or recent image captured by the imaging device 22 to the server device 30. Thereafter, in step 84, the client device 10 waits for transmission of information from the server device 30, specifically, transmission of a three-dimensional model or the like.

In step S181, the server device 30 monitors whether or not the intra-area selected position and the image have been transmitted from the client device 10.

Then, in a case where the server device 30 receives the intra-area selected position, the image, and the like from the client device 10 (YES in step S181), in step S182, the server device 30 acquires, by the three-dimensional model acquisition unit 304, the three-dimensional model corresponding to the processing candidate state from the three-dimensional model storage unit 305. To be precise, the three-dimensional model corresponding to the intra-area selected position in the area corresponding to the processing candidate information is acquired.

Next, in step S183, the server device 30 estimates, by the VPS processing unit 303, a relative positional relationship (relative pose information) between the drone 20 and the object corresponding to the three-dimensional model on the basis of the image received in step S181 and the three-dimensional model acquired in step S182.

Next, in step S184, the server device 30 transmits the three-dimensional model acquired in step S162 and the relative positional relationship (relative pose information) between the drone 20 and the object corresponding to the three-dimensional model estimated in step S183 to the client device 10. Thereafter, the server device 30 monitors transmission of new information from the client device 10 in step S181.

Once the three-dimensional model and the relative pose information estimated in step S183 are transmitted from the server device 30 to the client device 10 in step S184, it is confirmed in step S84 that the client device 10 has received the information from the server device 30, and the processing in the client device 10 proceeds.

Then, in step S85, the client device 10 transmits the three-dimensional model received in step S84, the relative pose information estimated in step S183, and the movement route generation command to the drone 20. Thereafter, route planning is performed in the drone 20. During the processing in the drone 20, the client device 10 monitors whether or not the user has made the return instruction in step S86 in the present embodiment. In a case where the return instruction has not been made, the client device 10 continues monitoring, and in a case where the return instruction has been made, the return instruction is transmitted to the drone 20 in step S87, and the processing is completed.

In step 281, the drone 20 monitors whether or not the three-dimensional model, the relative pose information, and the command for generating the movement route have been transmitted from the client device 10.

Then, in a case where the drone 20 receives the three-dimensional model, the relative pose information, and the like from the client device 10 (YES in step S281), in step S282, the drone 20 estimates, the odometry estimation unit 204, the current moving body pose of the drone 20. That is, the current position coordinates (latitude, longitude, and altitude) of the drone 20 and the orientation of the drone 20 are specified. Then, the drone 20 estimates, by the odometry estimation unit 204, a relative position between the actual position of the drone 20 and the object corresponding to the three-dimensional model on the basis of the three-dimensional model and the relative pose information received in step 281 and the current moving body pose of the drone 20 estimated in step S282.

Next, in step S283, the drone 20 generates, by the route planning unit 205, the movement route with respect to the object corresponding to the three-dimensional model on the basis of the relative position between the actual position of the drone 20 estimated in step S282 and the object corresponding to the three-dimensional model.

Thereafter, in step S284, the drone 20 performs control by the flight control unit 206 in such a way that flight according to the movement route generated in step S283 is performed. As a result, the drone 20 can perform survey, inspection, photogrammetry (three-dimensional model generation), and the like of the object by imaging the object while performing autonomous movement. Since the processing of steps S285 to S288 is similar to the processing of steps S265 to S268 in FIG. 6, a detailed description thereof is omitted.

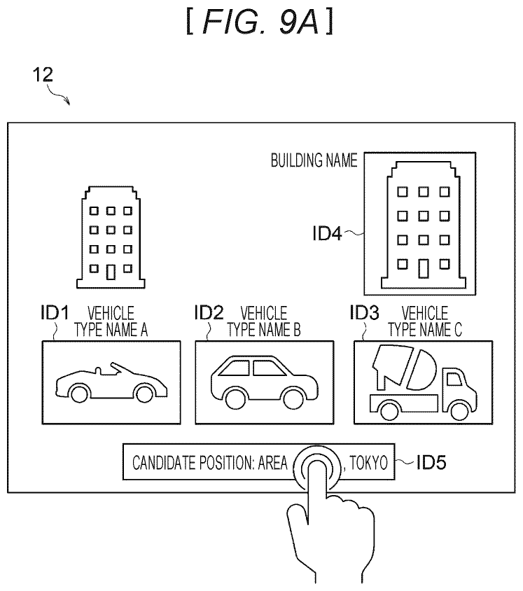

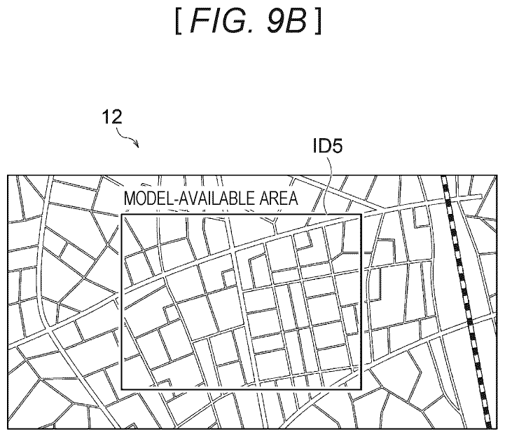

A specific example of the flow of the processing in FIG. 8 will be described with reference to FIGS. 9A to 9B and FIGS. 10A to 10C. FIG. 9A illustrates a state in which a target of the route planning processing illustrated in FIG. 8 is selected from the processing candidate information displayed on the display 12 illustrated in FIG. 5. In FIG. 9A, as an example, the processing target candidate ID5 specified with an area indicator including the address is selected as the target of the route planning processing.

The operation illustrated in FIG. 9A is detected in step S38 in FIG. 3, and with the detection as a trigger, the processing of FIG. 8 starts. In the present embodiment, once the operation illustrated in FIG. 9A is performed, the client device 10 displays an area corresponding to the processing candidate information selected by the user as illustrated in FIG. 9B (step S81). In FIG. 9B, a map indicator of the area corresponding to the processing candidate information is drawn on the display 12.

In the present embodiment, the user can select a range or a section to be a target of acquisition of a three-dimensional model from a part of or the entire area displayed on the display 12. FIG. 10A illustrates a state in which partial information is selected from the area corresponding to the processing candidate information displayed in FIG. 9B. Specifically, FIG. 10A illustrates a state in which the user partially selects the processing target from the area displayed on the display 12. The range or area selected by the user is indicated by Reference Sign Sa, and this information is specified as the intra-area selected position.

Once the intra-area selected position is selected in FIG. 10B, the intra-area selected position selected by the user and the latest or recent image captured by the drone 20 are transmitted from the client device 10 to the server device 30 (step S83), and the server device 30 transmits a three-dimensional model corresponding to the intra-area selected position selected by the user and a relative positional relationship (relative pose information) between an object corresponding to the three-dimensional model and the drone 20 to the client device 10 (steps S181 to S184). Then, the client device 10 transmits the three-dimensional model corresponding to the intra-area selected position selected by the user and the relative positional relationship (relative pose information) between the object corresponding to the three-dimensional model and the drone 20 to the drone 20 (step S85).

Thereafter, the drone 20 estimates a relative position between the actual position of the drone 20 and the object corresponding to the three-dimensional model by using the three-dimensional model corresponding to the intra-area selected position selected by the user, the relative pose information between the object corresponding to the three-dimensional model and the drone 20, and the current position of the drone 20 (step S282). FIG. 10B conceptually illustrates a state in which the relative positional relationship between the three-dimensional model of the object acquired on the basis of the intra-area selected position selected in FIG. 10A and the drone 20 is specified. FIG. 10B illustrates a plurality of three-dimensional models of a plurality of objects included in the intra-area selected position. The odometry estimation unit 204 conceptually specifies the positional relationship as illustrated in FIG. 10B.

Thereafter, the drone 20 generates, by the route planning unit 205, a movement route with respect to the object corresponding to the three-dimensional model on the basis of the relative position between the actual position of the drone 20 and the object corresponding to the three-dimensional model (step S283). FIG. 10C conceptually illustrates a state in which the route planning processing with respect to the object is executed on the basis of the three-dimensional model of the object acquired on the basis of the intra-area Selected position selected in FIG. 10A.

Note that processing candidate information in which the object detected by the object detection processing unit 302 is set as the processing candidate and processing candidate information in which the outdoor area specified by the VPS processing unit 303 in step 133 is set as the processing candidate are shown as the processing candidate information in the table illustrated in FIG. 4. On the other hand, in a case where the drone 20 is positioned indoors, the VPS processing unit 303 can specify a predetermined area in the building imaged by the drone 20 in the building.

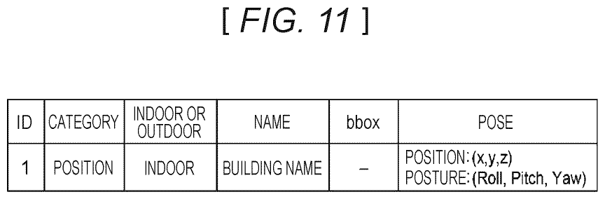

FIG. 11 illustrates an example in which a predetermined area in the building imaged by the drone 20 in the building is specified as the processing candidate information. In FIG. 11, the processing candidate information indicating the inside of the building having a three-dimensional model as the processing candidate is specified with ID1. In the column of category related to ID1 in FIG. 11, a notation of “position” is shown as the type of the information, “indoor” is shown, and the name (including address) of the building is shown, and a relative positional relationship between the drone 20 and the area (an internal space of the building) is shown in the column of pose.

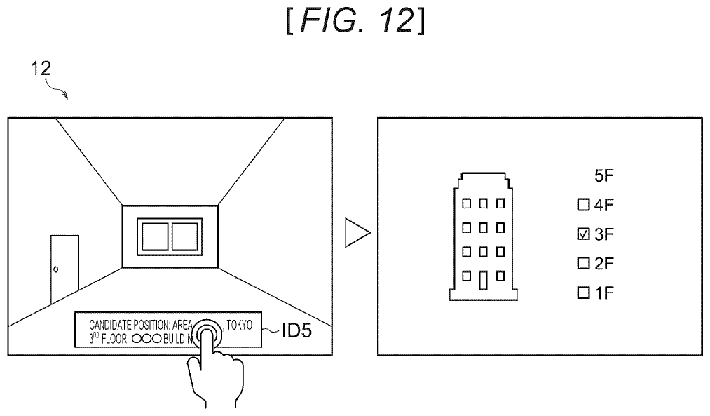

FIG. 12 illustrates an example in which the processing candidate information illustrated in FIG. 11 is displayed on the display 12. In the example of FIG. 12, first, the processing candidate information ID1 is displayed in a state of being superimposed on the image captured by the drone 20 as shown in the screen of the display 12 positioned on the left side in the drawing. The processing candidate information ID1 is displayed as the name of the building. In this example, as the user performs a touch operation on the processing candidate information ID1 on the display 12, the appearance of the building and the position (3rd floor in this example) of the drone 20 in the building are displayed on the display 12. In FIG. 12, a floor where the three-dimensional model of the internal structure in the building exists is displayed in a selectable mode (1st to 4th floors), and a floor where no three-dimensional model exists (5th floor) is displayed in an unselectable mode. Here, as the user selects a selectable portion (intra-area selected position), the route planning processing with respect to the object corresponding to the three-dimensional model associated with the selection is executed.

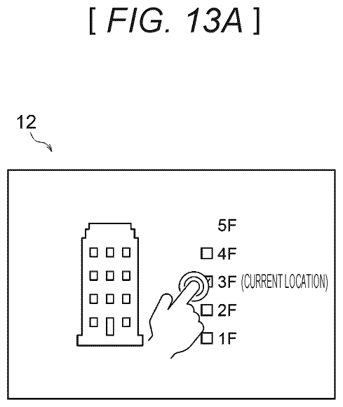

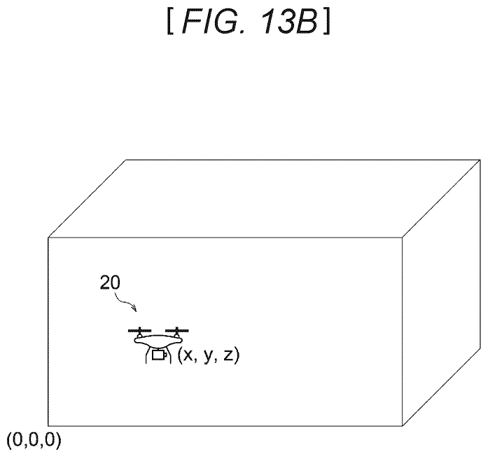

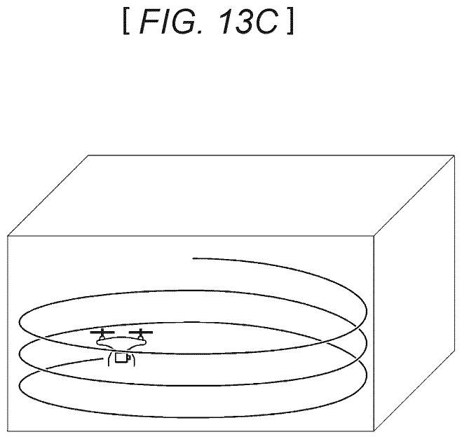

FIG. 13A illustrates a state in which the 3rd floor in the building is selected as a target of the route planning processing. Once the operation illustrated in FIG. 13A is detected, the processing of FIG. 8 starts.

In a case where the intra-area selected position (3rd floor) is selected in FIG. 13A, a three-dimensional model corresponding to the 3rd floor and a relative positional relationship (relative pose information) between an object corresponding to the three-dimensional model and the drone 20 are transmitted to the drone 20. Thereafter, the drone 20 estimates a relative position between the actual position of the drone 20 and the object corresponding to the three-dimensional model by using the three-dimensional model (the internal structure of the 3rd floor) corresponding to the intra-area selected position selected by the user, the relative pose information between the object corresponding to the three-dimensional model and the drone 20, and the current position of the drone 20. FIG. 10B conceptually illustrates a state in which the relative positional relationship between the three-dimensional model of the object acquired on the basis of the intra-area selected position (3rd floor) selected in FIG. 10A and the drone 20 is specified.

Thereafter, the drone 20 generates, by the route planning unit 205, a movement route with respect to the object corresponding to the three-dimensional model on the basis of the relative position between the actual position of the drone 20 and the object corresponding to the three-dimensional model. FIG. 13C conceptually illustrates a state in which the route planning processing with respect to the object is executed on the basis of the three-dimensional model of the object acquired on the basis of the intra-area selected position (3rd floor) selected in FIG. 13A.

In the information processing system S according to the present embodiment described above, an information acquisition step of acquiring an image captured by the imaging device 22 provided in the drone 20 and/or the position of the imaging device 22, and a model information acquisition step of acquiring processing candidate information indicating that an object for which processing based on a corresponding three-dimensional model is executable exists around the drone 20 and/or the three-dimensional model of the object existing around the drone 20 on the basis of the image captured by the imaging device 22 and/or the position of the imaging device 22 are executed.

Therefore, it is possible to efficiently and accurately execute processing for an object (processing target) existing around the drone 20. That is, in the information processing system S according to the present embodiment, the three-dimensional model of the object existing around the drone 20 can be acquired on the basis of the image and/or position of the drone 20, or the existence thereof can be confirmed on the basis of the processing candidate information. Then, by acquiring the three-dimensional model, processing such as survey, inspection, and photogrammetry (three-dimensional model generation) of the object corresponding to the three-dimensional model can be planned or executed using the three-dimensional model. Hitherto, in a case of executing processing for an object existing around a drone, first, processing of capturing an image of the object is executed in order to generate a three-dimensional model of the object, and then, drone route planning or the like is performed using the generated three-dimensional model. On the other hand, in the information processing system S, work of generating the three-dimensional model can be omitted, and the three-dimensional model with high processing accuracy can be acquired. Therefore, it is possible to efficiently and accurately execute processing for an object.

Furthermore, in the present embodiment, the processing candidate information indicating that the object for which processing based on the three-dimensional model is executable exists around the drone 20 and/or the three-dimensional model of the object is acquired on the basis of the position and the imaging direction of the imaging device 22. As a result, it is possible to suppress a situation in which a three-dimensional model of an object, such as an object positioned outside the image captured by the drone 20, which is highly likely not desired as a processing target by the user, is undesirably acquired. Therefore, it is advantageous from the viewpoint of improving the efficiency of processing.

Furthermore, in the present embodiment, first, the processing candidate information indicating that processing based on the three-dimensional model exists around the drone 20 is acquired (a first acquisition step corresponding to, for example, steps S31 to S34). Then, the processing candidate information is displayed on the display 12 in a mode selectable by the user (a processing candidate information drawing step corresponding to, for example, step S37). As a result, it is possible to suppress a situation in which a three-dimensional model having a large data amount is undesirably loaded on the client device 10, and it is thus possible to reduce a processing load.

Furthermore, after the processing candidate information is presented as described above, a three-dimensional model corresponding to the selected processing candidate information is acquired in response to selection of the processing candidate information by the user (a second acquisition step corresponding to, for example, steps S61 to S64). Then, a movement route of the drone 20 with respect to the object corresponding to the three-dimensional model is generated on the basis of the acquired three-dimensional model (a route planning step corresponding to, for example, S261 and S262 or S281 to S282). As a result, the processing based on the selection by the user is reliably executed, and usability for the user can be improved.

### Hardware Configuration

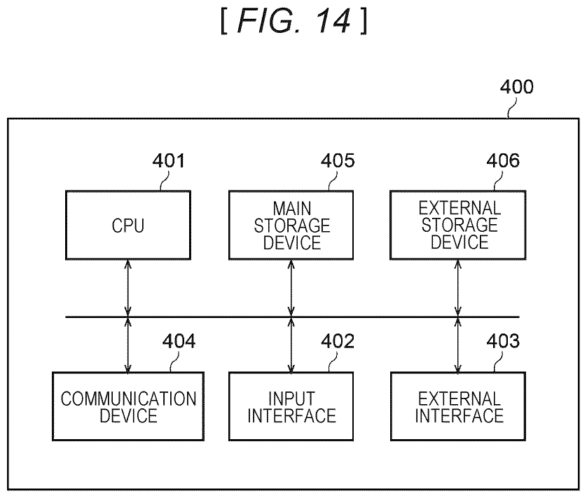

FIG. 14 illustrates an example of hardware configurations of the client device 10, the drone 20, and the server device 30. The client device 10, the drone 20, and the server device 30 can be implemented by a computer device 400. The computer device 400 includes a central processing unit (CPU) 401, an input interface 402, an external interface 403, a communication device 404, a main storage device 405, and an external storage device 406, which are interconnected by a bus. At least one of these elements does not have to be included in the client device 10, the drone 20, and the server device 30. Note that, in the present disclosure, the client device 10 corresponds to a first information processing device, and the server device 30 corresponds to a second information processing device.

The CPU (Central Processing Unit) 401 executes a computer program on the main storage device 405. The computer program is a program that implements the functional configuration of each of the client device 10, the drone 20, and the server device 30 described above. The computer program may be implemented not by one program but by a combination of a plurality of programs and scripts. The CPU 401 executes the computer program to implement each functional configuration.

The input interface 402 is a circuit for inputting an operation signal from an input device such as a keyboard, a mouse, or a touch panel to the client device 10, the drone 20, and the server device 30.

The external interface 403 displays, for example, data stored in the client device 10, the drone 20, and the server device 30, or data calculated by the client device 10, the drone 20, and the server device 30 on the display device. The external interface 403 may be connected to, for example, a liquid crystal display (LCD) or an organic electroluminescence display.

The communication device 404 is a circuit for the client device 10, the drone 20, and the server device 30 to communicate with an external device in a wireless or wired manner. Data used by the client device 10, the drone 20, and the server device 30 can be input from an external device via the communication device 404. The communication device 404 may include an antenna. Data input from the external device can be stored in the main storage device 405 or the external storage device 406.

The main storage device 405 stores a computer program, data necessary for executing the computer program, data generated by executing the computer program, and the like. The computer program is deployed and executed on the main storage device 405. The main storage device 405 is, for example, RAM, DRAM, or SRAM, but is not limited thereto. A storage unit for information and data in the communication device 404 may be constructed on the main storage device 405.

The external storage device 406 stores a computer program, data necessary for executing the computer program, data generated by executing the computer program, and the like. These computer programs and data are read into the main storage device 405 when the computer program is executed. Examples of the external storage device 406 include a hard disk, an optical disk, a flash memory, and a magnetic tape, but are not limited thereto.

Note that the computer program may be installed in the computer device 400 in advance or may be stored in a storage medium such as a CD-ROM. Furthermore, the computer program may be uploaded on the Internet.

Furthermore, the computer device 400 may be configured as a single device, or may be configured as a system including a plurality of computer devices connected to each other.

Note that the above-described embodiment has described examples for embodying the present disclosure, and the present disclosure can be implemented in various other forms. For example, various modifications, replacements, omissions, or combinations thereof can be made without departing from the gist of the present disclosure. Forms in which such modifications, replacements, omissions, and the like have been made are also included in the scope of the present disclosure and are likewise included in the invention described in the claims and the equivalent scopes thereof.

For example, in the above-described embodiment, a drone that is an unmanned flying object has been described as an example of the moving body. However, the technology of the present disclosure can also be applied to, for example, an autonomous vehicle, a robot, an underwater drone, and the like.

In the above-described embodiment, route planning by the route planning unit 205 is performed by the drone 20. However, the route planning may be performed by the client device 10 and/or the server device 30.

In this case, a processing load of the processor in the drone 20 can be reduced. In addition, in a case where the route planning is performed by the server device 30, it is easy to efficiently and appropriately perform the route planning of each moving body in a case where a plurality of moving bodies are caused to perform cooperative operation.

Furthermore, in the above-described embodiment, the client device 10 first transmits the moving body pose and the image received from the drone 20 to the server device 30, and receives the processing candidate information related to the three-dimensional model of the object existing around the drone 20 from the server device 30. Thereafter, once an instruction (operation) to acquire the three-dimensional model corresponding to the processing candidate information is confirmed from the user, the three-dimensional model acquisition command is transmitted to the server device 30, and the three-dimensional model from the server device 30 is received by the communication unit 101. Alternatively, the client device 10 may transmit the moving body pose and the image received from the drone 20 to the server device 30, and then acquire the three-dimensional model of the object around the drone 20 directly extracted.

Furthermore, the effects of the present disclosure described in the present specification are mere examples, and other effects may be provided.

Note that the present disclosure can have the following configurations.

### Item 1

An information processing method including:
an information acquisition step of acquiring an image captured by an imaging device provided in a moving body and/or a position of the imaging device; and
a model information acquisition step of acquiring processing candidate information indicating that an object for which processing based on a corresponding three-dimensional model is executable exists around the moving body and/or the three-dimensional model of the object existing around the moving body on the basis of the image captured by the imaging device and/or the position of the imaging device.

### Item 2

The information processing method according to item 1, in which in the information acquisition step, an imaging direction of the imaging device is acquired together with the position of the imaging device, and
in the model information acquisition step, the processing candidate information and/or the three-dimensional model is acquired on the basis of the position and the imaging direction of the imaging device.

### Item 3

The information processing method according to item 1 or 2, in which the model information acquisition step includes a first acquisition step of acquiring the processing candidate information, and
the information processing method further includes a processing candidate information drawing step of displaying the processing candidate information on a display in a mode selectable by a user.

### Item 4

The information processing method according to any one of items 1 to 3, in which the model information acquisition step includes a second acquisition step of acquiring the three-dimensional model corresponding to the selected processing candidate information in response to selection of the processing candidate information by the user, and
the information processing method further includes a route planning step of generating a movement route of the moving body for the object corresponding to the three-dimensional model on the basis of the three-dimensional model acquired in the second acquisition step.

### Item 5

The information processing method according to any one of items 1 to 4, in which in the model information acquisition step, the object is detected by image recognition from the image captured by the imaging device, and in a case where the three-dimensional model of the detected object is acquirable, the processing candidate information related to the detected object is created and/or the three-dimensional model is acquired.

### Item 6

An information processing device including:
an information acquisition unit that acquires an image captured by an imaging device provided in a moving body and/or a position of the imaging device; and
a model information acquisition unit that acquires processing candidate information indicating that an object for which processing based on a corresponding three-dimensional model is executable exists around the moving body and/or the three-dimensional model of the object existing around the moving body on the basis of the image captured by the imaging device and/or the position of the imaging device.

### Item 7

A computer program for causing a computer to execute:
an information acquisition step of acquiring an image captured by an imaging device provided in a moving body and/or a position of the imaging device; and
a model information acquisition step of acquiring processing candidate information indicating that an object for which processing based on a corresponding three-dimensional model is executable exists around the moving body and/or the three-dimensional model of the object existing around the moving body on the basis of the image captured by the imaging device and/or the position of the imaging device.

### Item 8

An information processing system including: a moving body; a first information processing device that communicates with the moving body; and a second information processing device that communicates with the first information processing device,
in which at least one of the first information processing device or the second information processing device includes:
an information acquisition unit that acquires an image captured by an imaging device provided in the moving body and/or a position of the imaging device; and
a model information acquisition unit that acquires processing candidate information indicating that an object for which processing based on a corresponding three-dimensional model is executable exists around the moving body and/or the three-dimensional model of the object existing around the moving body on the basis of the image captured by the imaging device and/or the position of the imaging device.

### REFERENCE SIGNS LIST

S Information processing system
10 Client device
12 Display
101 Communication unit
102 Processing candidate information holding unit
103 Processing candidate information drawing unit
104 Processing target extraction unit
105 Display unit
106 Input unit
20 Drone
201 Communication unit
202 Imaging unit
203 Position and posture acquisition unit
204 Odometry estimation unit
205 Route planning unit
206 Flight control unit
30 Server device
301 Communication unit
302 Object detection processing unit
303 VPS processing unit
304 Three-dimensional model acquisition unit
305 Three-dimensional model storage unit
ID0 to 05 Processing candidate information

1-8. (canceled)

9. An image processing apparatus comprising:
circuitry configured to
receive an image captured by an autonomous moving body, the image including an object,
receive a pose of the autonomous moving body,
acquire candidate information indicating at least one candidate for the object or an area around the autonomous moving body, the candidate information being acquired according to at least one of the acquired image or the acquired pose of the autonomous moving body, and
acquire at least one of a three-dimensional (3D) model of the object or a 3D model of the area around the autonomous moving body to be used for autonomous movement based on a selected candidate from among the acquired candidate information.

10. The image processing apparatus according to claim 9,
wherein the circuitry is further configured to transmit the at least one of the 3D model of the object or the 3D model of the area around the autonomous moving body to the autonomous moving body.

11. The image processing apparatus according to claim 10,
wherein the circuitry receives the image captured by the autonomous moving body and the pose information of the autonomous moving body from the autonomous moving body,
wherein the circuitry is further configured to
transmit the image and the pose information to a server,
transmit information of the selected candidate to the server, and
receive the at least one of the 3D model of the object or the 3D model of the area from the server, and
wherein the circuitry transmits the at least one of the 3D model of the object or the 3D model of the area around the autonomous moving body to the autonomous moving body.

12. The image processing apparatus according to claim 11,
wherein the circuitry is further configured to
receive the candidate information from the server,
display the at least one acquired candidate in a display, and
acquire a user selection with respect to the at least one candidate displayed in the display.

13. The image processing apparatus according to claim 11,
wherein the circuitry is further configured to
receive a relative positional relationship between the autonomous moving body and the object from the server, the relative positional relationship being estimated based on the image and the pose, and
transmit the relative positional relationship to the autonomous moving body.

14. The image processing apparatus according to claim 9,
wherein the circuitry is further configured to transmit the at least one of the 3D model of the object or the 3D model of the area around the autonomous moving body to a client device.

15. The image processing apparatus according to claim 14,
wherein the circuitry receives the image captured by the autonomous moving body and the pose information of the autonomous moving body from the client device, and
wherein the circuitry is further configured to
transmit the acquired candidate information to the client device, and
receive information of the selected candidate from the client device.

16. The image processing apparatus according to claim 15,
wherein the circuitry is further configured to
estimate a relative positional relationship between the autonomous moving body and the object based on the image and the pose, and
transmit the relative positional relationship to the client device.

17. The image processing apparatus according to claim 15,
wherein the selected candidate is based on candidate information displayed on a display of the client device.

18. The image processing apparatus according to claim 15,
wherein the circuitry is further configured to determine whether the at least one of the 3D model of the object or the 3D model of the area around the autonomous moving body is stored in a storage, and
wherein the circuitry acquires the candidate information indicating the at least one candidate for the object or the area from the storage when the at least one of the 3D model of the object or the 3D model of the area is stored in the storage.

19. The image processing apparatus according to claim 18,
wherein the circuitry is further configured to
perform an object recognition on the received image, and
determine whether the 3D model of the object corresponding to the recognized object is stored in the storage, and
wherein the circuitry acquires the candidate information indicating the at least one candidate for the object from the storage when the 3D model of the object is stored in the storage.

20. The image processing apparatus according to claim 18,
wherein the circuitry is further configured to
perform a positioning process based on the received image and the received pose, the positioning process being for specifying an area around the autonomous moving body, and
determine whether the 3D model corresponding to the area specified in the positioning process is stored in the storage, and
wherein the circuitry acquires the candidate information indicating the at least one candidate for the area from the storage when the 3D model of the area is stored in the storage.

21. The image processing apparatus according to claim 18,
wherein the circuitry is further configured to notify the client device that candidate information does not exist when the at least one of the 3D model of the object or the 3D model of the area is not stored in the storage.

22. The image processing apparatus according to claim 9,
wherein the candidate information includes a position of the object corresponding to the 3D model in the image or a name of the 3D model of the object or the 3D model of the area.

23. The image processing apparatus according to claim 9,
the candidate information includes a name or an address of the area.

24. The image processing apparatus according to claim 9,
wherein the at least one of the 3D model of the object or the 3D model of the area around the autonomous moving body includes information to cause the autonomous moving body to generate a navigation route for the autonomous movement.

25. An image processing method comprising:
receiving an image captured by an autonomous moving body and a pose of the autonomous moving body, the image including an object;
acquiring candidate information indicating at least one candidate for the object or an area around the autonomous moving body, the candidate information being acquired according to at least one of the acquired image or the acquired pose of the autonomous moving body; and
acquiring at least one of a three-dimensional (3D) model of the object or a 3D model of the area around the autonomous moving body to be used for autonomous movement based on a selected candidate from among the acquired candidate information.

26. The image processing method according to claim 25, further comprising:
transmitting the at least one of the 3D model of the object or the 3D model of the area around the autonomous moving body to the autonomous moving body.

27. The image processing method according to claim 25, further comprising:
transmitting the at least one of the 3D model of the object or the 3D model of the area around the autonomous moving body to a client device.

28. A non-transitory computer-readable medium having embodied thereon a program, which when executed by a computer causes the computer to function as execute an information processing method, the method comprising:
receiving an image captured by an autonomous moving body and a pose of the autonomous moving body, the image including an object;
receiving a pose of the autonomous moving body;
acquiring candidate information indicating at least one candidate for the object or an area around the autonomous moving body, the candidate information being acquired according to at least one of the acquired image or the acquired pose of the autonomous moving body; and
acquiring at least one of a three-dimensional (3D) model of the object or a 3D model of the area around the autonomous moving body to be used for autonomous movement based on a selected candidate from among the acquired candidate information.
